(19) United States
(12) Patent Application Publication
(10) Pub. No.: US 2004/0067790 A1
(43) Pub. Date: Apr. 8, 2004

(54) Gaming device having multiple terminating symbols

(76) Inventors: Lance R. Peterson, Reno, NV (US); Anthony J. Baerlocher, Reno, NV (US); Paulina Rodgers, Reno, NV (US)

Correspondence Address: Bell, Boyd & Lloyd LLC, P.O. Box 1135, Chicago, IL, 60690-1135, US

(21) Appl. No.: 10/419,493

(22) Filed: Apr. 22, 2003

Related U.S. Application Data
(63) Continuation-in-part of application No. 09/652,312, filed on Aug. 31, 2000, now Pat. No. 6,632,139.

(51) Int. Cl. A63F 13/00

(52) U.S. Cl. 463/20; 463/25

(57) ABSTRACT

A gaming device including at least two reels having a plurality of symbols. The symbols include award symbols, at least one terminator symbol and at least one activator symbol. In one embodiment, a plurality of spins are provided to the player. The player activates the reels and obtains awards associated with the award symbols indicated on one or more of the paylines associated with the reels. If the terminator symbol or activator symbol are separately indicated on the reels in one or more of the spins, the player receives an award associated with those symbols. If the terminator symbol and the activator symbol are simultaneously indicated on the same payline associated with the reels, the activator symbol activates the terminator symbol and the game ends. The player then receives the total award accumulated by the player in that game.

### PRIORITY CLAIM

This application is a continuation-in-part of and claims the benefit of U.S. patent application Ser. No. 09/652,312, filed Aug. 31, 2000.

### CROSS REFERENCE TO RELATED APPLICATIONS

This application is related to the following commonly-owned co-pending patent applications: “GAMING DEVICE WITH BONUS SCHEME PROVIDING AWARDS ASSOCIATED WITH MOVEMENTS ALONG PATH,” Ser. No. 09/583,429, Attorney Docket No. 0112300-016; “GAMING DEVICE HAVING AN INDICATOR SELECTION WITH PROBABILITY-BASED OUTCOME BONUS SCHEME,” Ser. No. 09/605,809, Attorney Docket No. 0112300-024; and “GAMING DEVICE WITH BONUS SCHEME PROVIDING INCREASED REWARD FOR SELECTING RELATED SYMBOLS” Ser. No. 09/605,023, Attorney Docket No. 0112300-025.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

Many existing gaming machines, such as traditional slot machines, include bonus rounds. Typically, a bonus round begins when the player reaches a bonus triggering event in the primary game of the gaming device. In slot machines with reels, the triggering event usually occurs when the player reaches a predetermined combination of symbols on the reels. Usually the bonus scheme provides the player with an opportunity to gain bonus value before the bonus round terminates.

In existing bonus schemes with symbol generators such as reels and wheels, the bonus round terminates after the player has had a predetermined number of opportunities to gain bonus value or after the player has accumulated a predetermined amount of bonus values. These bonus rounds do not terminate when the player reaches a predetermined combination of symbols.

To increase player enjoyment and excitement, it is desirable to provide players with new bonus schemes for gaming devices which include symbol generators and symbol terminating conditions.

### SUMMARY OF THE INVENTION

The present invention provides a gaming device and method which has a bonus scheme which includes one or more symbol generators, a plurality of symbols and one or more terminating conditions. The symbol generator is a device, method or system which generates certain symbols as an outcome for a player. Preferably, the symbol generator is a computer program or mathematical formula, and the computer of the gaming device inputs certain symbols into the generator which then generates certain symbols as output. The term symbol, as used herein, includes any representation in audio, visual or audio-visual form whether in motion or at rest such as letters, numerals, characters and pictures, drawings or other representations of people, places or things.

The gaming device can graphically represent the symbol generator as any mechanism or any other system or device. For example, a symbol generator can be represented as a plurality of reels (in physical or video form) in a gaming device, a spinning wheel (in physical or video form) or a set of dice. The reels, spinning wheel and dice would include a plurality of symbols, such as a mixture of characters and numeric values.

The bonus scheme of the present invention also includes one or more terminating conditions which terminate the bonus round after the player has had an opportunity to gain at least one bonus value. The terminating condition occurs when the symbol generator generates two or more predetermined symbols. For example, a terminating condition could be a combination of letters, such as X, Y and Z, generated by the gaming device. Preferably, the terminating condition occurs at one or more predetermined result areas. The result area is a certain area where symbols must be located in order for a terminating condition to occur.

In the context of reels, the result area is two or more symbol areas, preferably defined by one or more lines extending from outer reel to outer reel. In the context of a spinning wheel, the result area is preferably two or more areas, preferably identified by result pointers.

In operation, the bonus round is initiated when a triggering event occurs. Once the bonus round is initiated, the gaming device (preferably randomly) generates a plurality of symbols, preferably by enabling the player to push a play button or other activator device. Depending upon which symbols are generated and the design of the bonus scheme, the player may gain a bonus value, gain no bonus value or the bonus round may terminate. If a terminating condition does not occur, the gaming device provides the player with any earned bonus value and then generates a second set of symbols by enabling the player to push the play button again. This process continues until a terminating condition occurs.

In a preferred embodiment of the present invention, the symbol generator is a plurality of reels which display a plurality of symbols. In another preferred embodiment, the symbol generator is one or more spinning wheels. In either case, the symbol generator has the capacity to generate numeric and non-numeric symbols (i.e., the numeral five and a character). The terminating condition occurs when the symbol generator generates at least two non-numeric symbols in a specified result area. As long as the player avoids this terminating condition, the gaming device awards the player with bonus value equal to the sum of all numeric symbols displayed in the result area.

The present invention provides a gaming device with a bonus scheme which involves symbol generators and terminating conditions. Whether the generator is a plurality of reels or a spinning wheel, the player may continue to spin the reels or the spinning wheel with the aim of gaining bonus values, until the player reaches a terminating condition. The terminating condition occurs when the symbol generator generates two or more predetermined symbols which cause the bonus round to terminate.

In one embodiment, the present invention provides a gaming device including at least two symbol generators such as at least two reels having a plurality of symbols and one or more paylines associated with the reels. It should be appreciated that the symbol generators may be at least one reel, at least one wheel or any other suitable symbol generators. The symbols include award symbols, at least one terminator symbol and at least one terminator activator symbol or activator symbol. The award symbols, terminator symbol and activator symbol may be any type of symbol such as numbers, wild symbols, symbols associated with the theme of the game or any suitable symbols as desired by the game implementor. Additionally, any suitable number of terminator symbols and activator symbols, and at least one terminator symbol and activator symbol, may be employed on the reels in a game. A plurality of awards are associated with the award symbols. The awards may be values, credits, multipliers, free spins, free games or any other suitable award.

In a game, the terminator symbol terminates or ends the activations or spins of the reels in a game only when the terminator symbol is activated by an activator symbol in the game. In each play, if the terminator symbol is randomly generated and the activator symbol is not randomly generated, the game does not terminate. Also in each play, if the activator symbol is randomly generated and the terminator symbol is not randomly generated, the play of the game continues. When the terminator symbol and the activator symbol are simultaneously indicated on the same payline in one of the spins of the reels, the activator symbol activates the terminator symbol. The spin of the terminator symbol causes the spins of the reels to end and therefore, ends the game. The gaming device includes a spins remaining display, which indicates the number of spins remaining in a game and a total award display, which indicates the total award accumulated by the player in the game. At the end of a game, the player receives the total award indicated by the total award display.

The gaming device therefore spins the reels in a game for a plurality of spins and provides any awards associated with the symbols such as one or more award symbols indicated on one or more of the paylines in the spins until an activated terminator symbol is indicated on the reels or there or no spins remaining in the game. When the terminator symbol and the activator symbol are simultaneously indicated on the same payline, the terminator is activated and the game ends. The player then receives the total of the awards accumulated by the player in the game.

In one embodiment, one or more awards are associated with the terminator symbol such that when the terminator symbol is indicated on one of the paylines on the reels, the award associated with the terminator symbol is added to the player's total award in the game. In another embodiment, an award such as a multiplier is associated with the activator symbol such that if the activator symbol is indicated on one of the paylines associated with the reels, any awards received in that spin are multiplied by the multiplier associated with the indicated activator symbol. In this embodiment, the gaming device continues to spin the reels until there are no spins remaining in the game or until the activator symbol and the terminator symbol are simultaneously indicated on one of the paylines on the reels. In a further embodiment, the multiplier associated with the indicated activator symbol multiplies any awards provided to the player in a plurality of spins of the reels. In another embodiment, the multiplier associated with the indicated activator symbol multiplies any awards provided to the player in all of the spins in the game. In a further embodiment, a modifier such as a multiplier is provided to the player at the beginning of a game. In one aspect of this embodiment, each activator symbol indicated on the reels increases the multiplier by a predetermined or randomly determined amount. In another aspect, a plurality of activator symbols increases the multiplier by a predetermined or random amount. The activator symbols may increase the multiplier in each spin of the reels, a plurality of spins of the reels or all of the spins of the reels.

In another embodiment, the terminator is activated based on a pre-determined or randomly determined number of activator symbols being indicated on one of the paylines on the reels. For example, in a particular game, three activator symbols must be indicated on one of the paylines in the spins of the reels before the terminator symbol is activated in the game. Thus, the gaming device activates the reels until three activator symbols are indicated on a payline associated with the reels in one or more spins. When the three activator symbols are indicated on the payline, the terminator is activated and the game ends when the activated terminator symbol is indicated on the payline. It should be appreciated that the number of activator symbols needed to activate the terminator symbol may be randomly determined, predetermined, determined based on the player's wager in the game or according to any other suitable determination method.

In one aspect of this embodiment, the designated or determined number of activator symbols are simultaneously indicated on the payline. In another aspect of this embodiment, the activator symbols are indicated in sequential spins of the reels. It should be appreciated that sequential indication of the symbols in sequential spins of the reels may occur on a single reel, a plurality of reels or all of the reels in a game. In another embodiment, the activator symbols and the terminator symbol are simultaneously indicated on the payline of the reels to activate the terminator symbol. In one aspect of this embodiment, the activator symbols and the terminator symbol are indicated on the payline in sequential spins of the reels to activate the terminator symbol. In another aspect of this embodiment, at least one of the activator symbols and the terminator symbol are simultaneously indicated on the payline to activate the terminator symbol.

In a further embodiment, a probability of a symbol being indicated on one or more of the reels is associated with the symbols. In one aspect of this embodiment, the probabilities associated with the terminator symbol and activator symbol are greater than the probability associated with at least one of the other at symbols on the reels. In another embodiment, the probabilities associated with the terminator symbol and the activator symbol are greater than a plurality of the probabilities associated with the other symbols on the reels. In another embodiment, the probabilities associated with the terminator symbol and the activator symbol are greater than all of the probabilities associated with the other symbols on the; reels.

In another embodiment, a bonus award is provided to the player when a pre-determined or randomly determined number of activator symbols are indicated on one of the paylines in one or more spins in the game. For example in a game, the gaming device provides a bonus award when five activator symbols are indicated on one of the paylines in the game. The gaming device activates the reels as described above, and if five indicator symbols are indicated on the reels in one or more spins of the reels, the player receives a bonus award in the game. The bonus award may be multipliers, values, prizes, credits, free spins, free games or any suitable award.

In a further embodiment of the present invention, the processor designates a number of spins of the reels at the beginning of a game such that the spins of the reels ends when there are no spins remaining or when an activated terminator symbol is indicated on the payline associated with the reels. The number of spins may be randomly determined, predetermined, based on a player's wager or determined according to any suitable method.

In an alternative embodiment of the present invention, at least one of the symbols indicated on the payline associated with the reels changes into an activator symbol or a terminator symbol in one or more spins of the reels. Changing the indicated symbols into activator symbols or terminator symbols increases the probability that the terminator will be activated in a game and that the game will end. In one aspect of this embodiment, the terminator symbols and activator symbols are included on separate, independent reels such that the symbols on the reel including the terminator symbol or symbols, will only change into a terminator symbol when those symbols are indicated on a designated payline or paylines associated with the reels. Similarly, the symbols on the reel including the activator symbol or symbols will only change into an activator symbol when those symbols are indicated on the payline or paylines associated with the reels.

In another alternative embodiment, a plurality of terminator symbols and activator symbols are included on separate, independent reels in a game. In this embodiment, the processor generates designated pairs of terminator symbols and activator symbols where each of the terminator symbols corresponds to a specific activator symbol. Thus, the terminator symbols are only activated when the terminator symbol and its corresponding activator symbol are simultaneously indicated on the same payline associated with the reels. In one aspect of this embodiment, the terminator symbols and the activator symbols are included on separate, independent reels. In another aspect of this embodiment, the terminator symbols and the activator symbols are included on any of the reels where the corresponding terminator symbols and activator symbols are included on different reels.

In a further embodiment, at least one activator symbol activates a terminator symbol for a designated number of spins. For example, in a game, an activator symbol is indicated on the reels in a spin. The activator symbol activates any terminator symbols that appear on the reels in the next five spins of the reels. Therefore, any terminator symbols indicated on the reels in one of the next five spins becomes activated and ends the game. If a terminator symbol is not indicated on the reels in the next five spins of the reels after the activator symbol is indicated on the reels, the terminator symbol does not become activated. The designated number of spins may be randomly determined, pre-determined, determined based on a wager made by the player or determined according to any suitable determination method.

In another embodiment, a plurality of terminator symbols and at least one activator symbol are included on the reels in a game. In this embodiment, the activator symbol activates any terminator symbols that are indicated after or at the same time as the activator symbol on the reels. Once a terminator symbol is activated on a reel, the reel including the activated terminator symbol terminates or stops spinning for the remainder of the game. The remaining reels, which do not include activated terminator symbols, continue to spin to indicate symbols in the game. The game ends when all of the reels are terminated (or include activated terminator symbols) or when there are no spins remaining in the game.

It is therefore an advantage of the present invention to provide a gaming device including a game having a multiple element termination scheme.

Another advantage of the present invention is to provide a gaming device including a game having a multiple event termination scheme.

A further advantage of the present invention is to provide a gaming device that includes a combination of game elements to trigger a termination event in a game.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1A is a front perspective view of one embodiment of the gaming device of the present invention.

FIG. 1B is a front perspective view of another embodiment of the gaming device of the present invention.

FIG. 2 is a schematic block diagram of the electronic configuration of one embodiment of the gaming device of the present invention.

FIG. 3 is a top plan view of the reels, symbol areas and result lines in one embodiment of the present invention.

FIG. 4 is a top plan view of the spinning wheel, symbol areas and result pointers in one embodiment of the present invention.

FIG. 5 is a flow diagram of one embodiment of the present invention;

FIG. 6 is a top plan view of the reels, symbols and non-terminating condition in one embodiment of the present invention.

FIG. 7 is a top plan view of the reels, symbols and terminating condition in one embodiment of the present invention.

FIG. 8 is a top plan view of the reels, symbols and another terminating condition in one embodiment of the present invention.

FIG. 9 is a top plan view of the reels, symbols and bonus values in one embodiment of the present invention.

FIG. 10 is a top plan view of the reels, symbols and background screen in one embodiment of the present invention.

FIG. 11 is a top plan view of the spinning wheel, symbols and terminating condition in one embodiment of the present invention.

FIG. 12 is a top plan view of two spinning wheels, symbols and terminating condition in one embodiment of the present invention.

FIG. 13 is an enlarged elevation view of one embodiment of the gaming device of the present invention.

FIGS. 14A to 14E are enlarged elevation views of an example of an embodiment of the present invention where the game is based on a specific theme associated with the game.

### DETAILED DESCRIPTION OF THE INVENTION

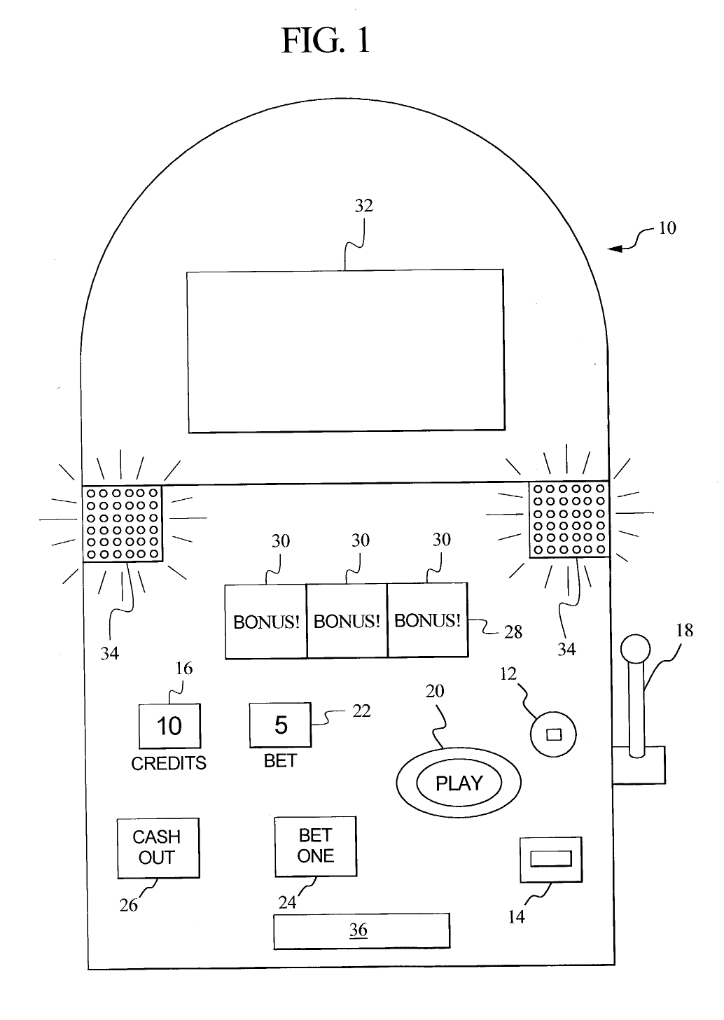

Referring now to the drawings, FIG. 1 generally illustrates a gaming device 10 of one embodiment of the present invention, which is preferably a slot machine having the controls, displays and features of a conventional slot machine. Gaming device 10 is constructed so that a player can operate gaming device 10 while standing or sitting. However, it should be appreciated that gaming device 10 can be constructed as a pub-style table-top game (not shown) which a player can operate preferably while sitting. Gaming device 10 can also be implemented as a program code stored in a detachable cartridge for operating a hand-held video game device. Also, gaming device 10 can be implemented as a program code stored on a disk or other memory device which a player can use in a desktop or laptop personal computer or other computerized platform.

Gaming device 10 can incorporate any game such as slot, poker or keno in addition to any of their bonus triggering events which trigger the bonus scheme of the present invention. The symbols and indicia used on and in gaming device 10 may be in mechanical, electrical or video form.

As illustrated in FIG. 1, gaming device 10 includes a coin slot 12 and bill acceptor 14 where the player inserts money, coins or tokens. The player can place coins in the coin slot 12 or paper money in the bill acceptor 14. Other devices could be used for accepting payment such as readers or validators for credit cards or debit cards. When a player inserts money in gaming device 10, a number of credits corresponding to the amount deposited is shown in a credit display 16. After depositing the appropriate amount of money, a player can begin the game by pulling arm 18 or pushing play button 20. Play button 20 can be any play activator used by the player which starts any game or sequence of events in the gaming device.

As shown in FIG. 1, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one.

Gaming device 10 also has a display window 28 which contains a plurality of reels 30, preferably three to five reels in mechanical or video form. Each reel 30 displays a plurality of indicia such as bells, hearts, fruits, numbers, letters, bars or other images which preferably correspond to a theme associated with the gaming device 10. If the reels 30 are in video form, the gaming device 10 preferably displays the video reels 30 at video monitor 32 instead of at display window 28. Furthermore, gaming device 10 preferably includes speakers 34 for making sounds or playing music.

At any time during the game, a player may “cash out” and thereby receive a number of coins corresponding to the number of remaining credits by pushing a cash out button 26. When the player “cashes out,” the player receives the coins in a coin payout tray 36. The gaming device 10 may employ other payout mechanisms such as credit slips redeemable by a cashier or electronically recordable cards which keep track of the player's credits.

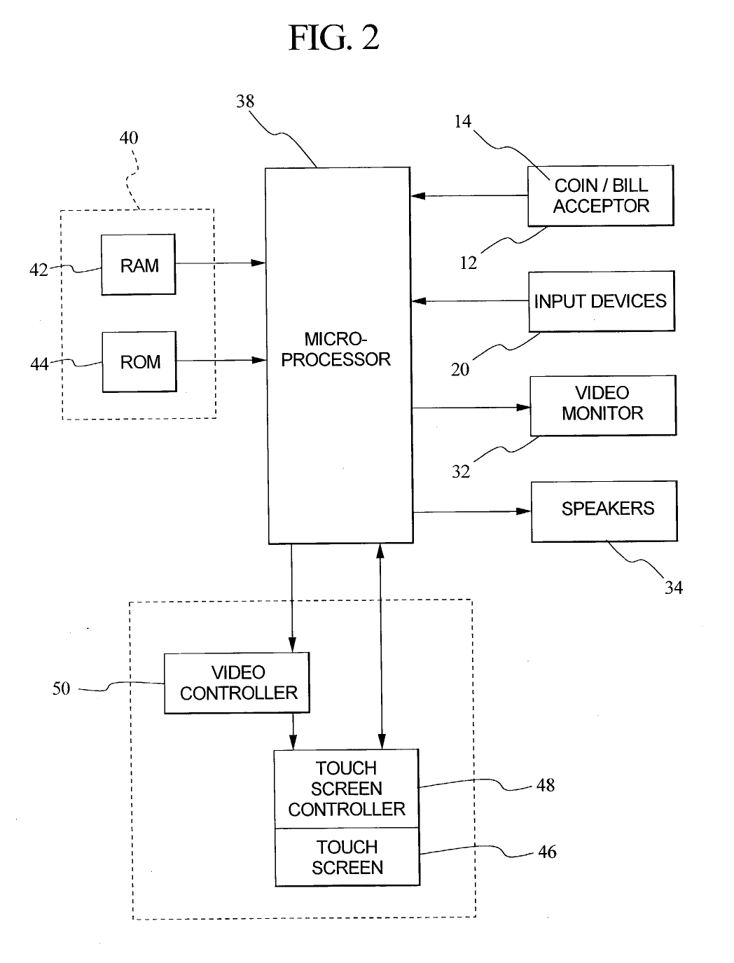

With respect to electronics, gaming device 10 preferably includes the electronic configuration generally illustrated in FIG. 2, including a processor 38, a memory device 40 for storing program code or other data, a video monitor 32 or other display device (i.e., a liquid crystal display) and at least one input device such as play buttons 20. The processor 38 is preferably a microprocessor or microcontroller-based platform which is capable of displaying images, symbols and other indicia such as images of people, characters, places, things and faces of cards. The memory device 40 can include random access memory (RAM) 42 for storing event data or other data generated or used during a particular game. The memory device 40 can also include read only memory (ROM) 44 for storing program code which controls the gaming device 10 so that it plays a particular game in accordance with applicable game rules and pay tables.

As illustrated in FIG. 2, the player preferably uses play buttons 20 to input signals into gaming device 10. Furthermore, it is preferable that touch screen 46 and an associated touch screen controller 48 are used instead of a conventional video monitor 32. Touch screen 46 and touch screen controller 48 are connected to a video controller 50 and processor 38. A player can make decisions and input signals into the gaming device 10 by touching touch screen 46 at the appropriate places. As further illustrated in FIG. 2, the processor 38 can be connected to coin slot 12 or bill acceptor 14. The processor 38 can be programmed to require a player to deposit a certain amount of money in order to start the game.

It should be appreciated that although a processor 38 and memory device 40 are preferable implementations of the present invention, the present invention can also be implemented using one or more application-specific integrated circuits (ASIC's) or other hard-wired devices, or using mechanical devices (collectively referred to herein as a “processor”). Furthermore, although the processor 38 and memory device 40 preferably reside on each gaming device 10 unit, it is possible to provide some or all of their functions at a central location such as a network server for communication to a playing station such as over a local area network (LAN), wide area network (WAN), Internet connection, microwave link, and the like. The processor 38 and memory device 40 are generally referred to herein as the “computer.”

With reference to FIGS. 1 and 2, to operate the gaming device 10, the player must insert the appropriate amount of money or tokens at coin slot 12 or bill acceptor 14 and then pull the arm 18 or push the play button 20. The reels 30 will then begin to spin. Eventually, the reels 30 will come to a stop. As long as the player has credits remaining, the player can spin the reels 30 again. Depending upon where the reels 30 stop, the player may or may not win additional credits.

In addition to winning credits in this manner, preferably gaming device 10 also gives players the opportunity to win credits in a bonus round. This type of gaming device 10 will include a program which will automatically begin a bonus round when the player has achieved a qualifying condition in the game. This qualifying condition can be a particular arrangement of indicia on the display window 28. The gaming device 10 also includes a display device such as a video monitor 32 shown in FIG. 1 enabling the player to play the bonus round. Preferably, the qualifying condition is a predetermined combination of indicia appearing on a plurality of reels 30. As illustrated in the three reel slot game shown in FIG. 1, the qualifying condition could be the text “BONUS!” appearing in the same location on three adjacent reels.

### BONUS SCHEME

If a player achieves a bonus triggering or qualifying condition while playing the game, the gaming device 10 automatically initiates the bonus round of the present invention. The bonus scheme of the gaming device of the present invention includes one or more symbol generators, a plurality of symbols and one or more terminating conditions.

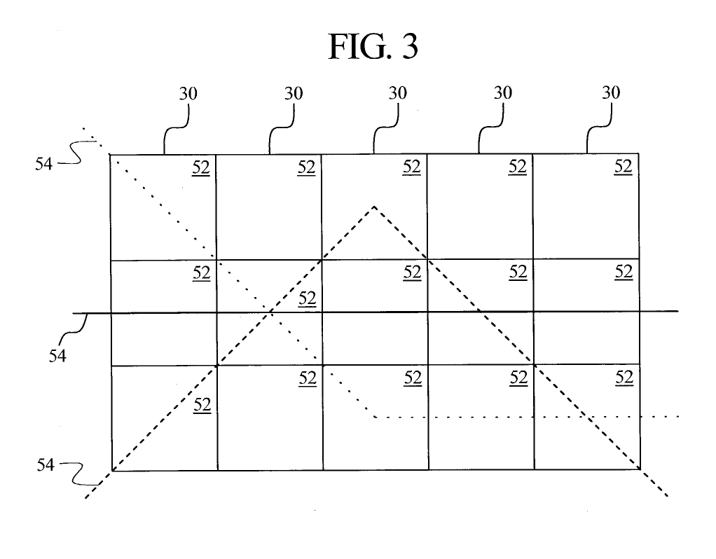

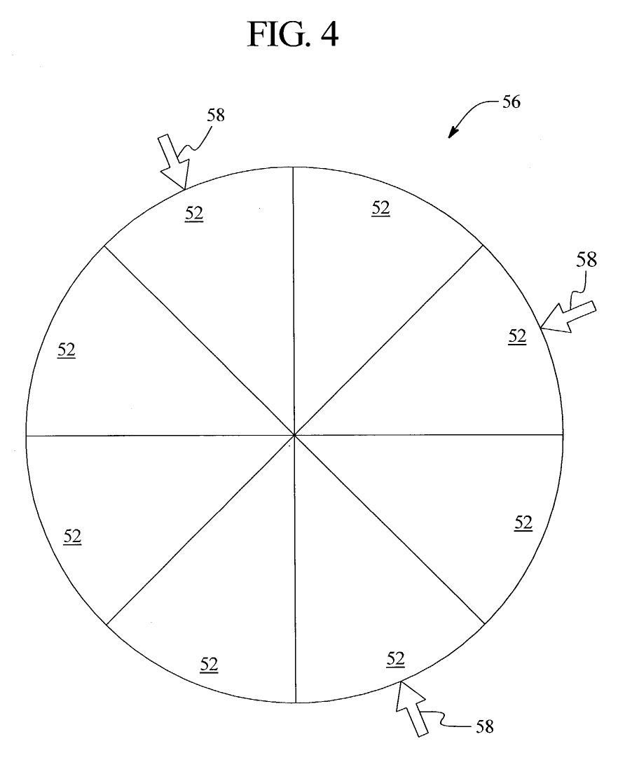

In one preferred embodiment shown in FIG. 3, the symbol generator is a plurality of reels 30 displayed by the gaming device. Reels 30 include a plurality of symbol areas 52 and one or more result areas. The result areas here are the symbol areas 52 which are intersected by one or more result lines 54, as shown in FIG. 3. In another embodiment, the symbol generator is a spinning wheel 56 which includes a plurality of symbol areas 52, as shown in FIG. 4. This symbol generator also includes one or more result areas which are defined and identified by result pointers 58 shown in FIG. 4. In both of these embodiments, the result areas are preferably the only symbol areas 52 where a terminating condition can occur.

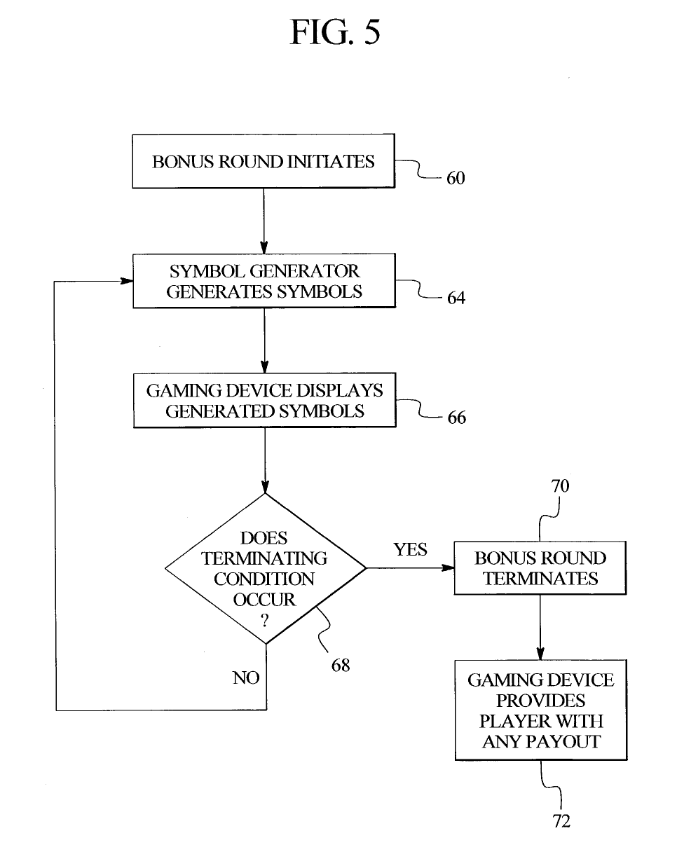

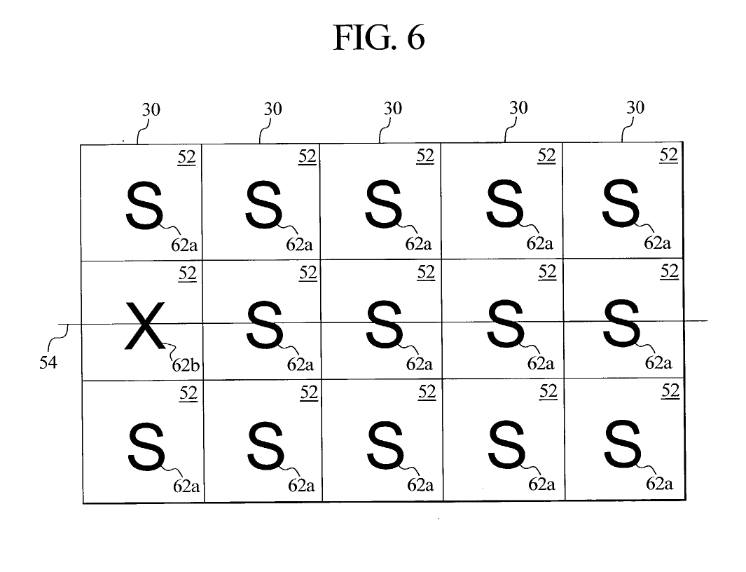

With reference to block 60 in FIG. 5, in operation the bonus round initiates when a bonus triggering event occurs. Once the bonus round initiates, the gaming device generates symbols 62 (shown in FIGS. 6 through 11) preferably by enabling the player to activate the symbol generator, as indicated by block 64 in FIG. 5. Preferably, the player can do so by pushing a play button 20 or another type of activator device.

Next, the gaming device displays the generated symbols 62, as indicated by block 66 in FIG. 5. Depending upon which symbols 62 the gaming device generates and where the gaming device displays them, a terminating condition may or may not occur. As indicated by blocks 70 and 72 in FIG. 5, if the terminating condition does occur, then the bonus round terminates and the gaming device provides the player with any payout due to the player. However, if a terminating condition does not occur, as indicated by diamond 68 in FIG. 5, the gaming device will then generate symbols 62 again, preferably by enabling the player to push play button 20 again. Furthermore, depending upon the particular design of the bonus scheme and the particular symbols 62 generated, the gaming device may also award the player with a bonus value prior to enabling the player to push play button 20 again. In such case, the gaming device preferably increases the value in a bonus value indicator (not shown).

As discussed earlier, in one preferred embodiment the symbol generator is a plurality of reels 30. The reels 30 display a plurality of symbols 62 at symbol areas 52, as shown in FIGS. 6 through 10. For example purposes only, in FIGS. 6 through 9 the result line 54 is located at the same location, horizontally extending through the middle row of the reels 30.

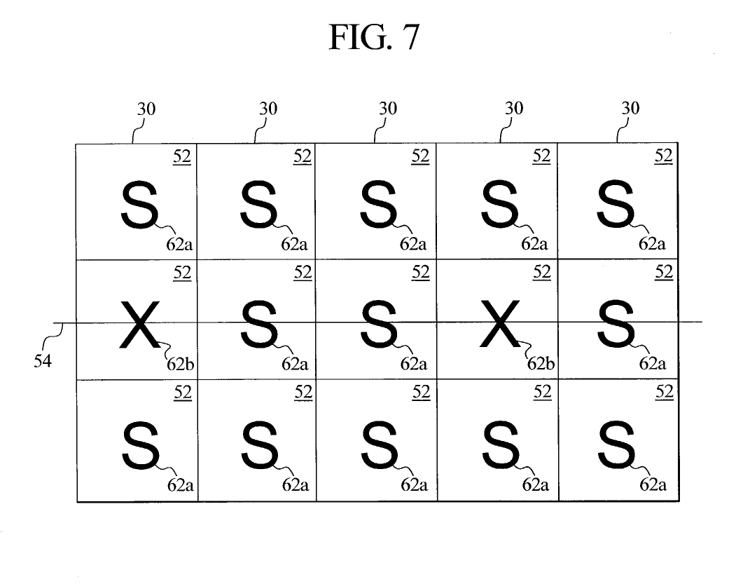

In this embodiment, illustrated in FIGS. 6 through 9, a variety of predetermined symbols 62 and predetermined combinations of symbols 62 can be used to define the terminating conditions. FIGS. 6 through 9 illustrate example partial or complete terminating conditions. It should be appreciated, however, that the present invention can include additional types of terminating conditions not illustrated here. In the example shown in FIG. 6, the symbol generator generated all of the symbols 62 shown. The symbols 62a which are of no particular type are indicated with the letter S and a particular symbol 62b (the letter X) is so indicated. In this example, the terminating condition is the letter X being displayed at any two symbol areas 52 located along the predetermined result line 54. Therefore, when the player reached X at only one symbol area 52 shown in FIG. 6, the bonus did not terminate because only one terminating symbol was displayed. When this same terminating condition is applied in another example shown in FIG. 7, the bonus round terminates because here the player generated the identical symbol 62b at two symbol areas 52 along result line 54.

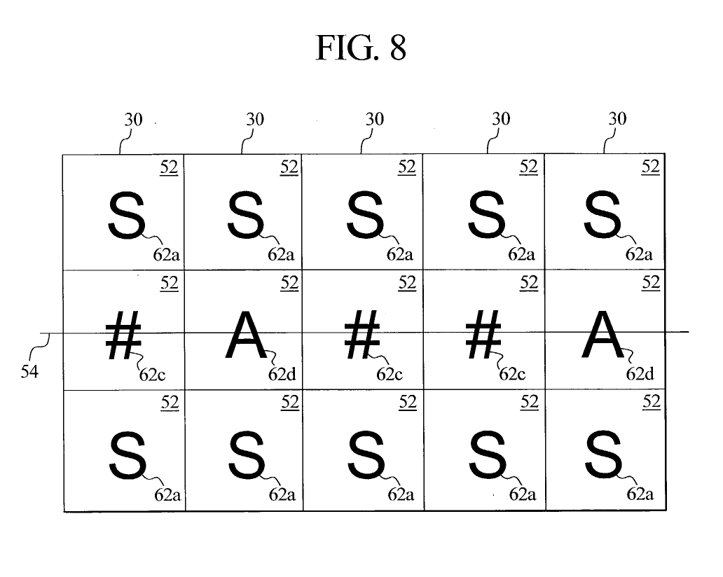

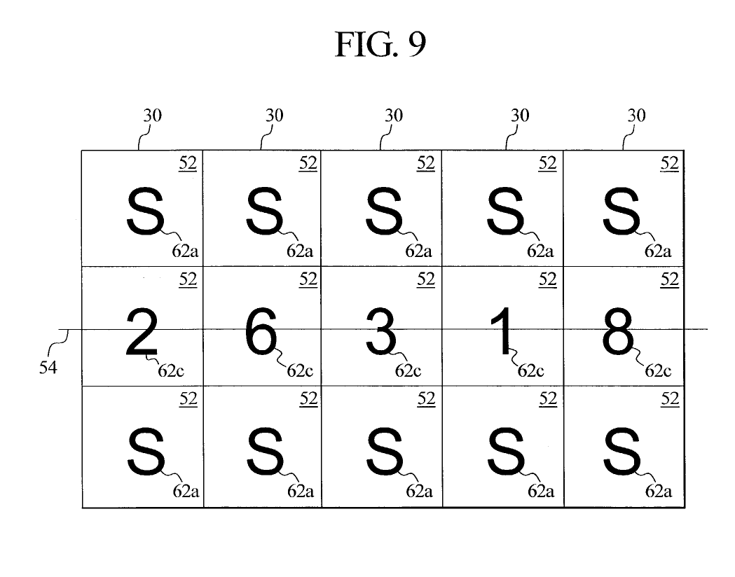

In an alternative embodiment shown in FIG. 8, the symbols 62 are either numeric symbols 62c or non-numeric symbols 62d. Here, the terminating condition is the display of two or more non-numeric symbols 62d at symbol areas 52 located along the result line 54. As shown in FIG. 8, after pushing play button 20, the player generated several symbols 62a of various types at a variety of symbol areas 52. The player also generated four numeric symbols 62c and one non-numeric symbol 62d, all of which are located along result line 54. The numeric symbols 62c are represented in FIG. 8 by number signs, and the non-numeric symbol 62d is represented by the letter A. The display of the letter A at two symbol areas 52 on the result area terminates the bonus round because it fulfills the terminating condition. Preferably in this alternative embodiment, if the player avoids the terminating condition, the gaming device awards the player with an award value equal to the sum of all numeric symbols 62d displayed along the result line 54. In the example shown in FIG. 9, the player generated various types of symbols 62a at various symbol areas 52. Here, all of the symbols generated along result line 54 are numeric symbols 62c. Consequently, the gaming device awards the player with a bonus value of twenty (the sum of 2+6+3+1+8).

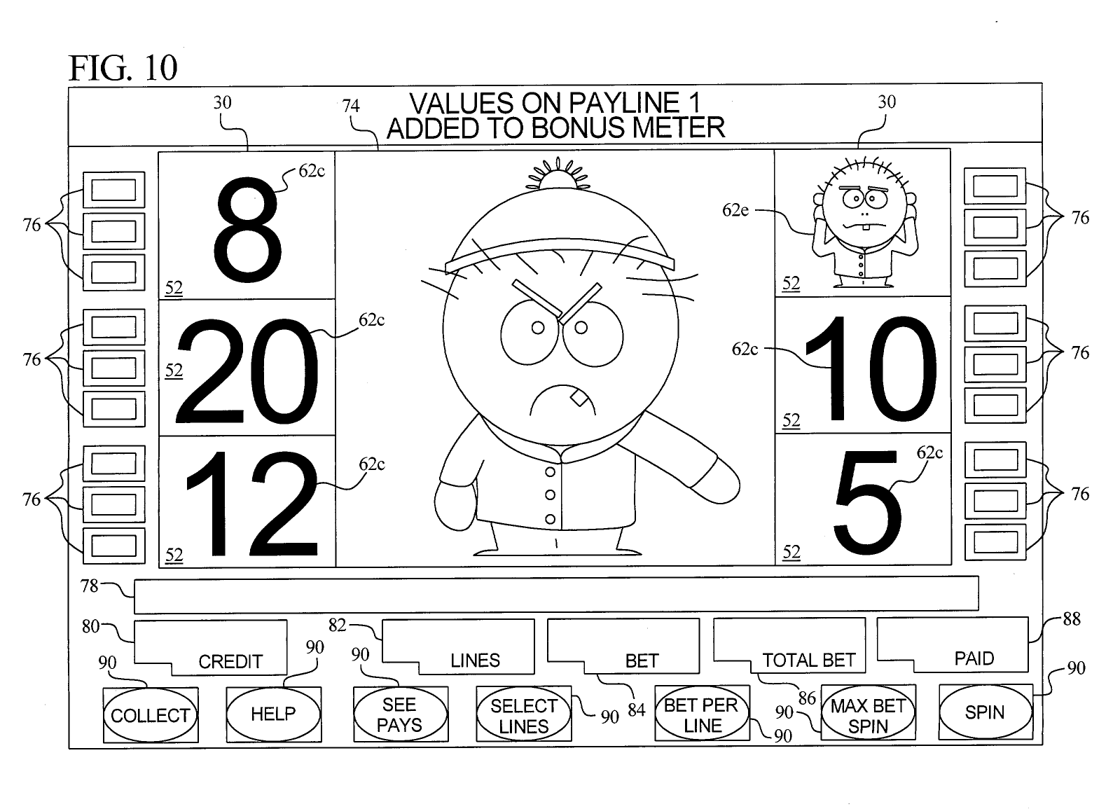

This alternative embodiment is further shown in the context of cartoon character symbols 62e and numeric symbols 62c, as shown in FIG. 10. Here, the symbols 62 are generated and displayed on two outer reels 30. The result area is the two symbol areas 52 located at the center of each reel 30. In this example bonus round, the gaming device generated numeric symbols 62c having the values, twenty and ten. Therefore, the gaming device awards the player with a value of thirty. The gaming device then enables the player to generate additional symbols 62 until a character symbol 62e is displayed at the result area, at which time the bonus round terminates.

Preferably this embodiment includes a background screen 74 for viewing purposes, as shown in FIG. 10. However, this background screen 74 can also be used to inform the player about the nature of the terminating condition for the bonus round. For example, a terminating condition could be a symbol 62 displayed at any result area and which is identical to (or is different from) the graphics of background screen 74.

As is apparent by viewing FIG. 10, this alternative embodiment preferably incorporates the South Park cartoon theme. SOUTH PARK™ is a trademark and service mark of Comedy Partners, New York, N.Y., and is used with permission from Comedy Partners by the assignee of the present invention. In addition, this preferred embodiment can include audio features (i.e., songs, voices, and other sound effects) which are consistent with the cartoon theme of this preferred embodiment.

Furthermore, preferably this preferred embodiment includes a line message 76 shown in FIG. 10. Line message 76 indicates, preferably in numeric form, the number of credits the player decided to bet for each line. Furthermore, preferably this preferred embodiment includes a plurality of windows for providing information to the player. As shown in FIG. 10, such windows include: (a) a bonus spin window (now shown) which displays the number of remaining bonus spins; (b) a credit window 78 which displays the number of credits which the gaming device provides to a player after each spin; (c) a credit balance window 80 which displays the player's current credit balance; (d) a line selection window 82 which displays the number of lines upon which the player is betting; (e) a bet window 84 which displays the number of credits the player is betting per line; (f) a total bet window 86 which displays the total credits which the player is betting; and (g) a pay window 88 which displays the total of credits which the gaming device has paid to the player on the previous game. Preferably, this preferred embodiment also includes a plurality of buttons 90 which the player uses to select game options and play the game, including a cash out button, help button, pay table button, select lines button, bet per line button, max bet button and stop spin button.

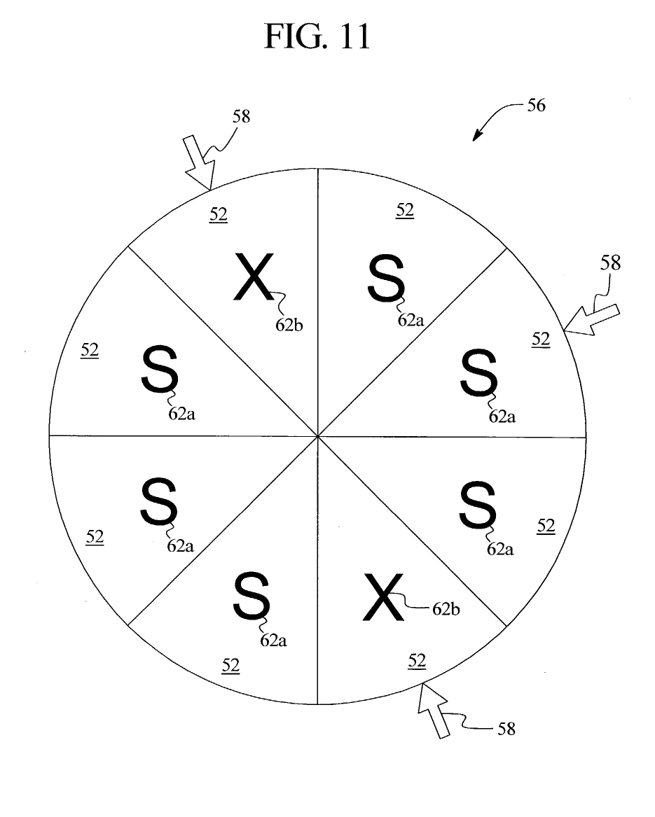

In the spinning wheel embodiment described earlier, preferably each symbol area 52 includes a symbol 62, as shown in FIG. 11. Depending upon the type of the terminating condition and the symbols 62 displayed at the result pointers 58, the bonus round may or may not terminate. Preferably, when the player pushes play button 20, the spinning wheel 56 rotates clockwise and/or counterclockwise and eventually comes to a stop. One or more result pointers 58 identifies certain symbols 62. The terminating condition occurs when the spinning wheel 56 stops spinning such that two or more predetermined symbols 62 or combinations of symbols 62 are aligned with the result pointers 58. Once this occurs, the bonus round terminates. In the example shown in FIG. 11, the terminating condition occurs when at least two result pointers point at two symbols 62b, the identical letters X. Here, the spinning wheel 56 stopped such that the result pointers 58 pointed at one symbol 62a, and two symbols 62b. Therefore, the bonus round terminates.

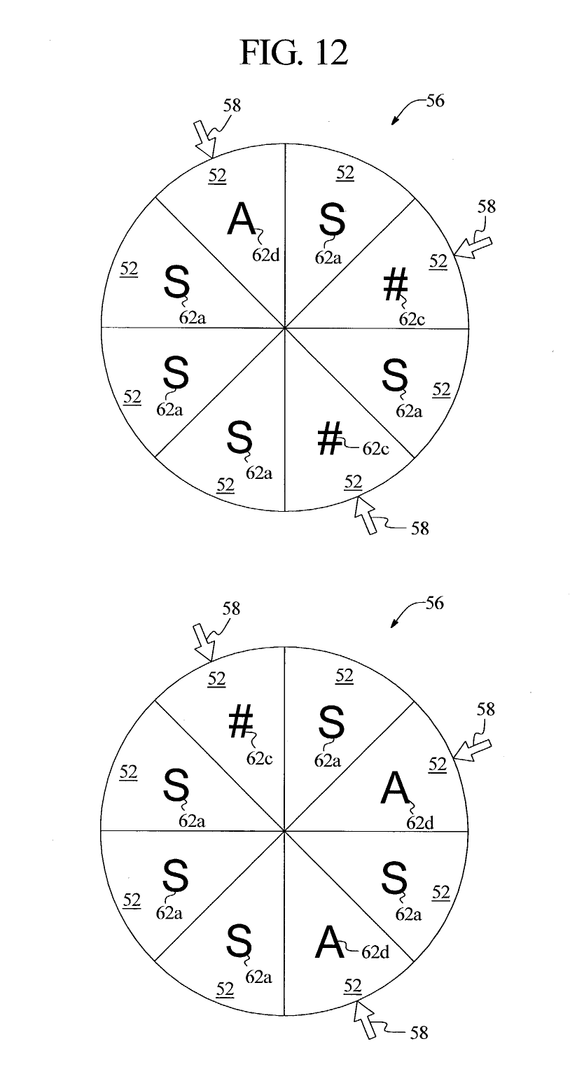

In an alternative spinning wheel embodiment shown in FIG. 12, the gaming device displays two spinning wheels 56. The symbols 62 displayed on the spinning wheels 56 are either numeric symbols 62c or non-numeric symbols 62d. Here, the terminating condition is the display of one or more non-numeric symbols 62d at each spinning wheel 56 at the symbol areas 52 located at the result pointers 58.

As shown in FIG. 12, after pushing play button 20, the player generated several symbols 62a of various types at a variety of symbol areas 52 at each spinning wheel 56. The player also generated one non-numeric symbol 62d at the upper spinning wheel 56 and two non-numeric symbols 62d at the lower spinning wheel 56, all being displayed at result pointers 58. The numeric symbols 62c are represented in FIG. 12 by number signs, and the non-numeric symbols 62d are represented by the letter A. In this example, the display of the letter A at one result pointer 58 of the upper spinning wheel 56, and the display of the letter A at two of the result pointers 58 terminates the bonus round because it fulfills the terminating condition. Preferably, in this embodiment if the player avoids the terminating condition, the gaming device awards the player with an award value equal to the sum of all numeric symbols 62c displayed at the result pointers 58 of both spinning wheels 56.

The bonus scheme of the gaming device of the present invention involves one or more symbol generators and one or more predetermined conditions which terminate the bonus round when certain symbols are generated and displayed. In one preferred embodiment, the symbol generator is a plurality of reels which display a plurality of symbols. In another preferred embodiment, the symbol generator is a spinning wheel which includes a plurality of symbols. In both preferred embodiments, the terminating condition includes two or more predetermined symbols or combinations of predetermined symbols which, when displayed at predetermined areas, effectively terminate the bonus round. This type of bonus scheme provides gaming devices with the capacity to terminate bonus rounds while providing players with excitement and enjoyment.

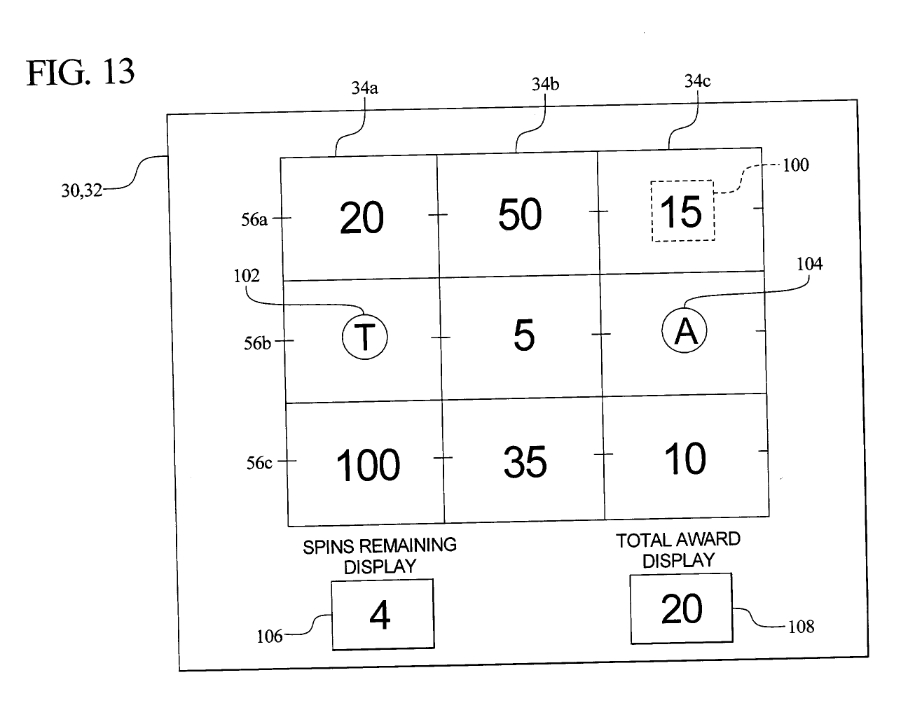

Referring to FIG. 13, another embodiment of the gaming device of the present invention is illustrated where the gaming device includes at least two reels 34 having a plurality of different symbols. The symbols include award symbols 100, at least one terminator symbol 102 and at least one terminator activator symbol or activator symbol 104. It should be appreciated that the symbols may include numbers, characters wild symbols or any suitable symbol or symbols. A plurality of awards are associated with the award symbols. The awards may be values, prizes, multipliers, free spins of the reels, free games and any other suitable types of awards. Additionally, one or more paylines 56 may be associated with the reels to indicate symbols on the reels. A spins remaining display 106 indicates the number of spins of the reels that are remaining in the game. A total award display 108 indicates the total amount of the awards accumulated by the player at any point in the game. The total award indicated in the total award display 108 at the end of the game is the total award that is provided to the player.

The terminator symbol 102 begins the game in an inactive state or in a non-terminating mode. The activator symbol 104 or terminator activator symbol activates the terminator when the terminator symbol 102 and the activator symbol 104 are simultaneously indicated on one of the paylines on the reels. If either the terminator symbol 102 or the activator symbol 104 are independently indicated on one of the paylines (i.e, both symbols are not simultaneously indicated on the same payline), then the terminator symbol 102 is not activated. If both symbols are indicated on one of the paylines simultaneously, then the terminator symbol 102 is activated and the game ends. Thus, the player obtains any awards associated with the symbols indicated on the reels until an activated terminator is indicated on the reels. The player obtains the total award indicated in the total award display 108.

It should be appreciated that the reels may include one or more terminator symbols 102 and/or activator symbols 104 as desired by the game implementor. Furthermore, the terminator symbol 102 and the activator symbol 104 may be designated with any suitable symbol on the reels. The terminator symbol 102 includes an award, a plurality of awards or no awards in a game.

In another embodiment, the activator symbol includes one or more awards in a game. In one aspect of this embodiment, the activator symbol includes a multiplier. Thus, when the activator symbol is indicated on one of the paylines, the multiplier associated with the activator symbol is multiplied by the sum of the awards associated with any award symbols indicated on the payline, and the multiplied award is added to the player's total award in the game. It should be appreciated that the multiplier may be randomly determined or predetermined in the game. In a further embodiment, a multiplier is provided to the player at the beginning of a game, wherein the multiplier has a designated value such as 2×. In one aspect of this embodiment, each activator symbol indicated on the reels in a game increases the multiplier by a predetermined or randomly determined amount. In another aspect, a plurality of activator symbols increases the multiplier by a predetermined or random amount. It should be appreciated that the activator symbols may increase the multiplier in each spin of the reels, a plurality of spins of the reels or all of the spins of the reels.

In a further embodiment, the gaming device provides a bonus award to the player when a designated number of activator symbols are indicated on one of the paylines in one or more spins of the reels. If the player obtains the designated number of activator symbols on the payline in one or more spins of the reels before the game ends, the gaming device provides a bonus award to the player. It should be appreciated that the number of activator symbols may be predetermined or randomly determined in the game, and the bonus award may be any suitable award as described above. It should also be appreciated that an award may be associated with an activator symbol. The award may be any suitable award such as values, prizes, credits, free spins, free games, points or any other type of award or prize.

In another embodiment of the present invention, the activator symbol 104 activates the terminator symbol 102 when a designated number of activator symbols 104 are indicated on the reels. For example, if three activator symbols are required to activate the terminator symbol 102 in a game, then the activator symbol 104 must be indicated on the payline for the designated number of times before the activator symbol 104 activates the terminator symbol. Once the terminator symbol 102 is activated, the game ends and the player receives the total award indicated in the total award display 108. An activator symbol counter (not shown) may be employed in a game to keep track of the number of activator symbols indicated in a game. Alternatively, an activator symbol display (not shown) may be included on the display device wherein individual activator symbols corresponding to the activator symbols on the reels are highlighted each time one or more of the activator symbols are indicated on the reels in the spins of a game. It should be appreciated that any suitable method of tracking the number of activator symbols indicated in a game may be employed in the present embodiment.

The designated number of activator symbols may be simultaneously or sequentially indicated on the payline associated with the reels. In one aspect of this embodiment, the designated number of activator symbols and the terminator symbol are simultaneously indicated on the payline associated with the reels to activate the terminator symbol. In another aspect of this embodiment, the designated activator symbols and the terminator symbol are indicated on the payline in sequential spins of the reels. In a further aspect of this embodiment, at least one of the activator symbols and the terminator symbols are simultaneously indicated on the payline associated with the reels to activate the terminator symbol. It should be appreciated that sequential indication of the symbols may occur on a single reel, a plurality of reels or all of the reels in a game.

In a further embodiment, a probability of being indicated on one of the paylines on the reels is associated with each of the symbols including the terminator symbol and the activator symbol. The probabilities may be randomly determined or pre-determined by the processor of the gaming device. In one embodiment, the probabilities associated with the terminator symbol 102 and the activator symbol 104 are greater than at least one of the probabilities associated with the award symbols on the reels. In another embodiment, the probabilities associated with the terminator symbol and the activator symbol are greater than a plurality of probabilities associated with the award symbols on the reels. In another embodiment, the probabilities associated with the terminator symbol and the activator symbol are greater than all of the probabilities associated with the award symbols indicated on the reels.

In another embodiment of the present invention, the gaming device or processor designates the number of spins provided to the player at the beginning of a game. The designated number of spins may be randomly determined, predetermined, determined based on a player's wager, or according to any suitable determination method. In this embodiment, a player activates or spins the reels until there are no spins remaining or until an activator symbol and a terminator symbol are simultaneously indicated on the reels, which activates the terminator symbol and ends the game.

In an alternative embodiment, the symbols indicated on the payline associated with the reels changes into a terminator symbol or an activator symbol in one or more spins of the reels. In this embodiment, when a symbol is indicated on the payline on the reels, the player receives the award associated with that symbol and then the symbol is changed or transformed into a terminator symbol or an activator symbol. Changing the indicated symbols into terminator symbols or activator symbols increases the probability that the terminator will be activated and the game will end. In one aspect of this embodiment, the reels in a game are independent reels including the terminator and activator symbols. One of the independent reels includes at least one terminator symbol and one of the reels includes at least one activator symbol. In this embodiment, the symbol indicated on the reel including the terminator symbol only change into a terminator symbol and similarly, the symbols indicated on the reel including the activator symbol only change into an activator symbol. In another aspect of this embodiment, the symbols on the reels that are indicated on the payline change into a terminator and/or an activator symbol in one or more spins of the reels. In this embodiment, the game ends when one of the terminator symbols is activated by one of the activator symbols in the game. It should be appreciated that the terminator and activator symbols may be included on any of the reels as long as at least one terminator symbol and at least one activator symbol are included on different reels.

In another embodiment, the processor designates pairs of terminator and activator symbols where only the activator symbol in that pair activates the terminator symbol in the same pair of symbols. Thus, a terminator symbol is only activated by the corresponding activator symbol in the same symbol pair. In this embodiment, the reels are activated until a terminator symbol and its corresponding activator symbol are simultaneously indicated on the payline associated with the reels. If a terminator symbol and a non-corresponding activator symbol (i.e., an activator symbol not in the same designated pair as the terminator symbol) are indicated on a payline, the terminator symbol is not activated. It should be appreciated that one or more terminator symbols may be associated or correspond to one or more activator symbols in a game.

In a further embodiment, at least one activator symbol activates a terminator symbol for a designated number of spins. For example, in a game, an activator symbol is indicated on the reels in a spin. The activator symbol activates any terminator symbols that appear on the reels in the next five spins of the reels. Therefore, any terminator symbols indicated on the reels in one of the next five spins becomes activated and ends the game. If a terminator symbol is not indicated on the reels in the next five spins of the reels after the activator symbol is indicated on the reels, the terminator symbol does not become activated. The designated number of spins may be randomly determined, predetermined, determined based on a wager made by the player or determined according to any suitable determination method.

In another embodiment, a plurality of terminator symbols and at least one activator symbol are included on the reels in a game. In this embodiment, the activator symbol activates any terminator symbols that are indicated after or at the same time as the activator symbol on the reels. Once a terminator symbol is activated on a reel, the reel including the activated terminator symbol terminates or stops spinning for the remainder of the game. The remaining reels, which do not include activated terminator symbols, continue to spin to indicate symbols in the game. The game ends when all of the reels are terminated (or include activated terminator symbols) or when there are no spins remaining in the game.

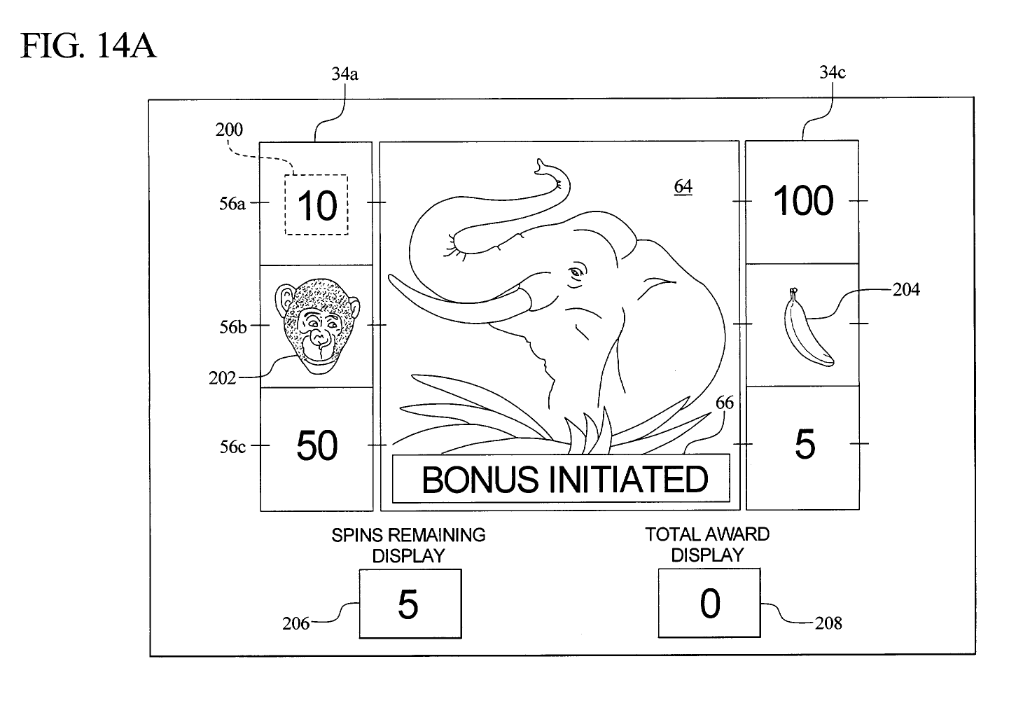

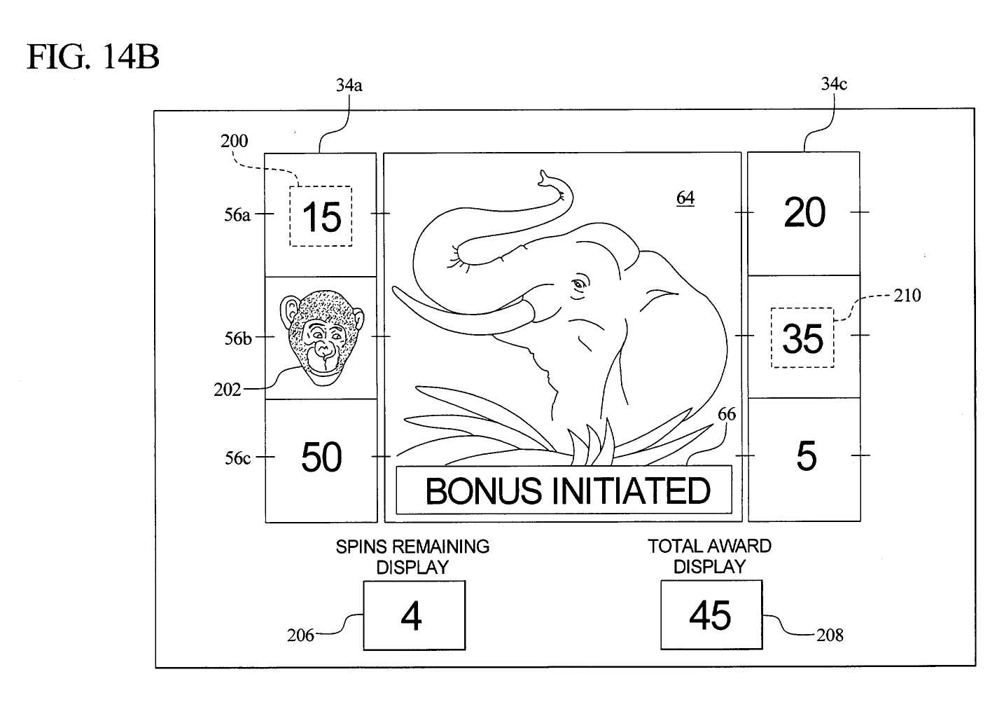

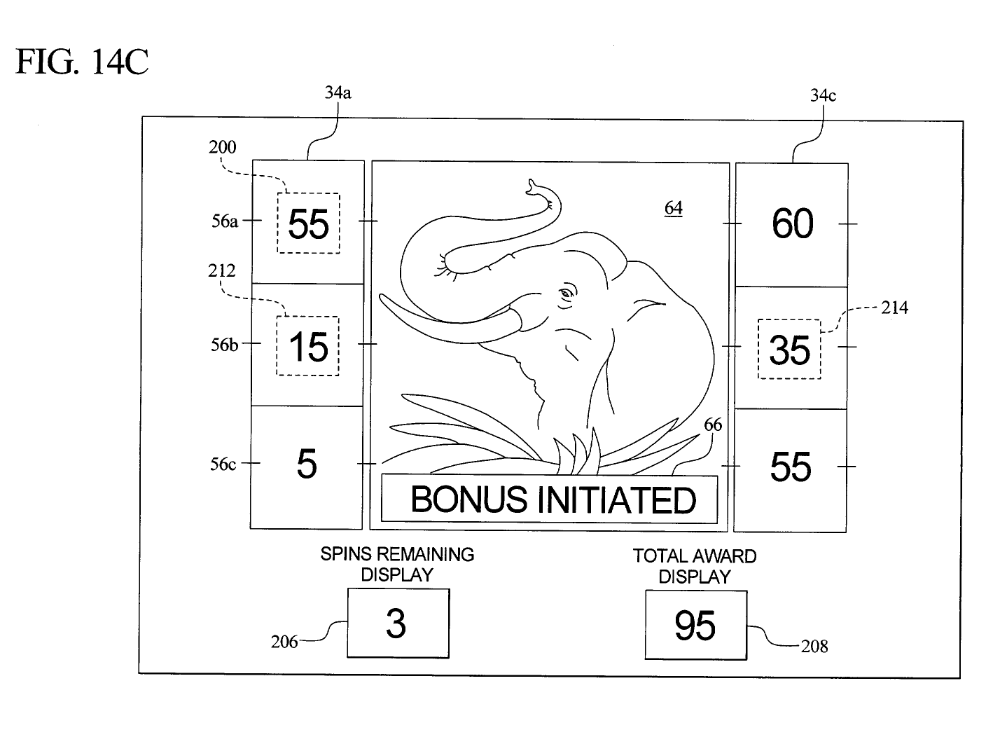

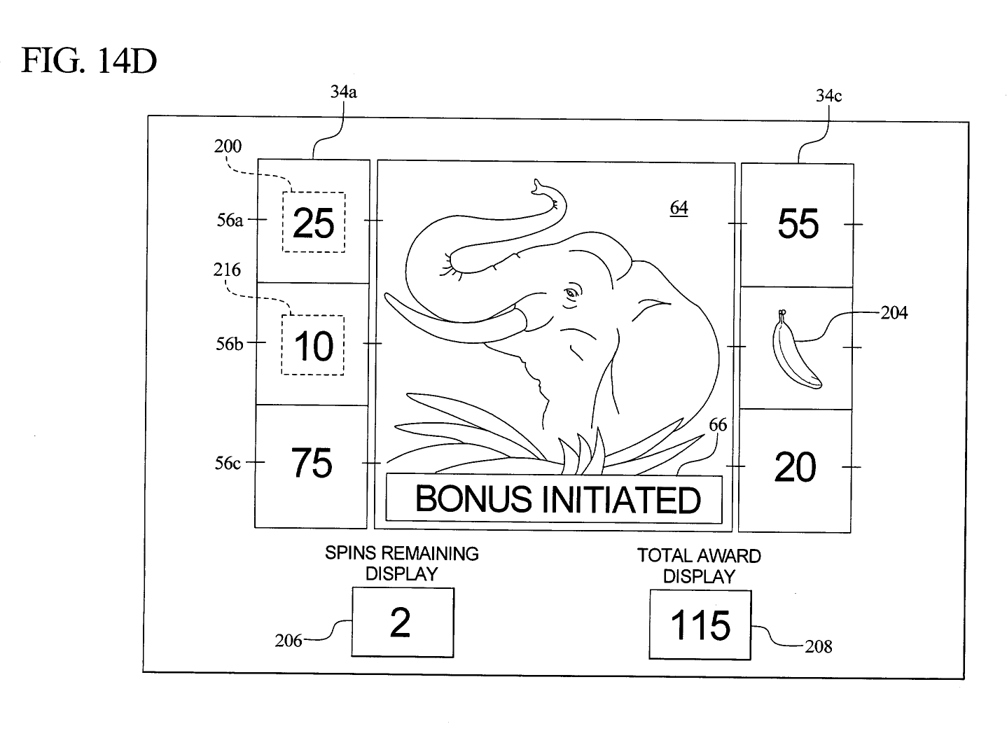

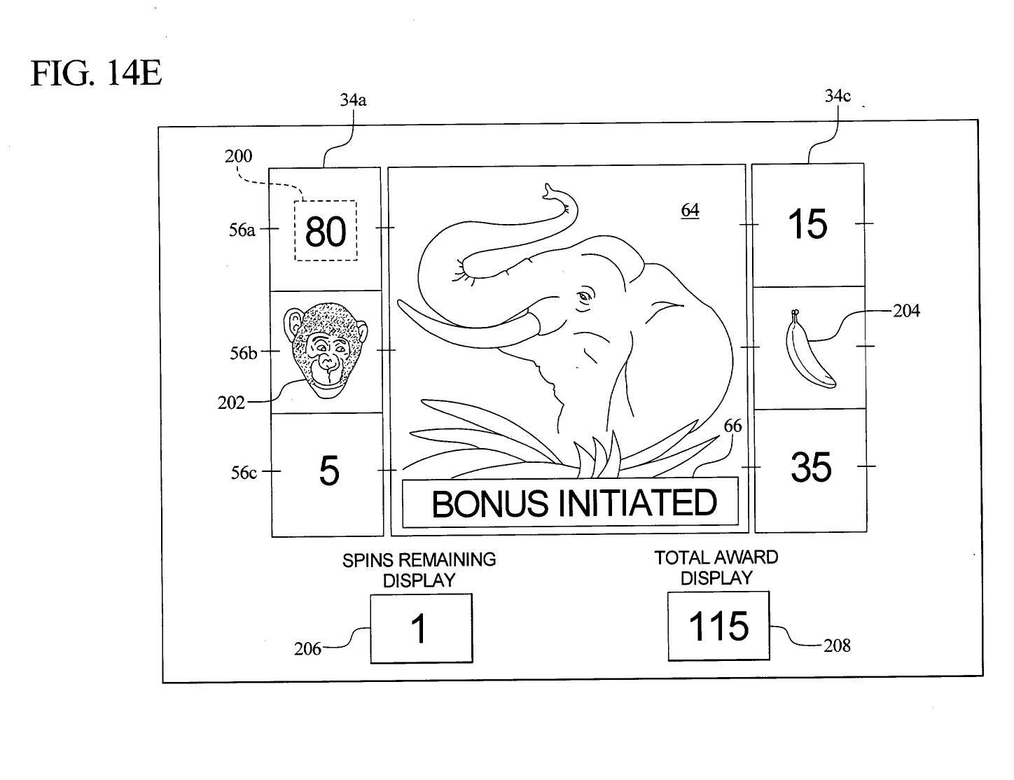

Referring to FIGS. 14A to 14E, an example of one embodiment of the present invention is illustrated where two reels are displayed in a game. The reels 34a and 34c include several symbols including award symbols 200, one terminator symbol 202 and one terminator activator symbol or activator symbol 204. In this example, the middle portion or middle area 64 may include additional reels to indicate symbol in the spins or include a display which provides animation or other information related to the theme of the game to the player. In this example, a prompt which indicates that the bonus mode or bonus game was initiated is displayed in the middle area or display 64. It should be appreciated that any suitable type of display, animation or picture may be displayed in the middle area or middle display 64. A spins remaining display 206 indicates the number of spins or spins of the reels that are remaining in a game. In addition, a total award display indicates the total award accumulated by the player in the game. At the end of the game, the player receives the total award indicated in the total award display 208.

In this example, the terminator symbol 202 is represented by a monkey or monkey face, which follows the theme of the game which is a jungle theme. It should be appreciated that the symbols such as the terminator symbol or the activator symbol may be any suitable symbol that is associated with the theme of the game or any other suitable symbol in the game. In this example, the activator symbol 204 is represented by a banana. When the terminator symbol 202 (i.e., the monkey) and the activator symbol 204 (i.e., the banana) are simultaneously indicated on one of the paylines such as payline 56b in the game, the activator symbol 204 activates the terminator symbol 202 and the game ends. The player then receives the total award indicated in the total award display 208. In this example, if award symbols are indicated on a designated payline such as payline 56b, then the player receives the sum of the awards associated with the award symbols indicated on that payline. If the terminator symbol 202 is indicated on the payline, but not the activator symbol 204, then the player receives the sum of the award associated with the terminator symbol 202 and the award associated with the award symbol 200 indicated on the payline. If the activator symbol 204 is indicated on the payline, but not the terminator symbol 202, then the player receives the award associated with the award symbol indicated on the payline modified by a modifier such as a multiplier which is randomly associated with the activator symbol 204. The multiplied award is added to the player's total award in the total award display 208. It should be appreciated that the modifier may be a multiplier, an additional value added to the player's award or any suitable modifier or modifier value.

Referring to FIG. 14B, the gaming device activates or spins the reels for the first time in the game. In this example, the payline 56b is the pre-determined payline which determines the award and/or if a terminating event occurs in the game. Therefore, in FIG. 14B, the terminator symbol 202 and an award symbol 210 are indicated on payline 56b. The gaming device therefore provides the sum of the award of thirty-five associated with the award symbol 210 plus the award associated with the terminator symbol 202, which is ten. The total award for this spin of the reels is forty-five and that award is added to the player's total award as indicated in the total award display 208. The spins of the reels or the game do not end in this spin because the terminator symbol 202 and the activator symbol 204 were not simultaneously indicated on the payline 56b. Therefore, the terminator symbol was not activated and the game did not end. The player only has four spins remaining as indicated in the spins remaining display 206 and presently has a total award of forty-five as indicated in the total award display 208.

Referring to FIG. 14C, the gaming device activates or spins the reels 34a and 34c for a second time in the game. The reel stops spinning and indicate award symbols 212 and 214 on payline 56b. The awards of fifteen and thirty-five associated with the award symbols 212 and 214, respectively, are summed together and added to the player's total award in the game. The player's new total award in the game is ninety-five, which is indicated in the total award display 208. The player now has only three spins remaining in the game as indicated by the spins remaining display 206.

Referring to 4D, the gaming device activates or spins the reels 34a and 34c another time in the game. The reels stop spinning and indicate an award symbol 216 and the activator symbol 204 on the payline 56b. Because the activator symbol 204 and the terminator symbol are not simultaneously indicated on the same payline, the activator symbol acts as a modifier. In this example, the activator symbol includes a “2×” multiplier. Therefore, the award in this spin is the award associated with the award symbol 216, which is ten, multiplied by the multiplier 2×, which is associated with the activator symbol 204. The award of twenty is therefore added to the player's total award and the player now has a total award of one hundred fifteen as indicated in the total award display 208. The player only has two spins remaining in the game as indicated by the spins remaining display 206.

Alternatively in another embodiment, the gaming device includes a total modifier such as a total multiplier and sets the total multiplier at the beginning of the game to a predetermined or randomly determined value such as 1×. When the activator symbol is indicated on the reels in a spin and no terminator symbol is indicated on the reels in that spin as described above, the activator symbol causes the total multiplier to increment a predetermined amount such as 1× to form a new total multiplier of 2×. The total multiplier multiplies the total award in the game. Thus in the above example, the award of ten associated with the award symbol 216 indicated on payline 56b associated with the reels (as shown in FIG. 14D) is added to the previous total award of ninety-five to give a total award of one hundred five. The total award of one hundred five is multiplied by the total multiplier 2× to generate a new total award of two hundred ten.

Referring to FIG. 14E, the gaming device spins or activates the reels 34a and 34c another time in the game. The reels stop spinning and indicate a terminator symbol 202 and an activator symbol 204 on the payline 56b. Because the terminator symbol and the activator symbol are simultaneously indicated on the same payline, the activator symbol 204 activates the terminator symbol 202. Thus, the terminator symbol, which is now activated, ends or terminates the spins of the reels in the game. The player receives the total award of one hundred fifteen indicated in the total award display 208. It should be appreciated that although the terminator symbol ended the game, the player only had one spin or spin remaining in the game and therefore the game would have ended in the player's next spin or spin of the reels.

It should be appreciated that any number of terminator symbols 202 and activator symbols 204 may be employed in a game. Additionally, a probability of being indicated on one or more paylines in a game may be associated with each of the symbols. In one embodiment, the probabilities associated with the terminator symbol and the activator symbol are greater than at least one of probabilities associated with the award symbols on the reels in a game. In another embodiment, the probabilities associated with the terminator symbol and the activator symbol are greater than a plurality of the probabilities associated with the award symbols in a game. In a further embodiment, the probabilities associated with the terminator symbol and the activator symbol are greater than all the probabilities associated with the award symbols on the reels in a game. It should be appreciated that the probabilities may be randomly determined or predetermined in the game. It should also be appreciated that the probabilities may all be the same, a plurality of the probabilities may be different or all of the probabilities may be different in a game.

Although in the present invention has been described with respect to symbol generators including at least one reel, it should be appreciated that the symbol generators may include at least one wheel or any other suitable symbol generator or generators.

While the present invention has been described in connection with what is presently considered to be the most practical and preferred embodiments, it is to be understood that the invention is not limited to the disclosed embodiments, but on the contrary is intended to cover various modifications and equivalent arrangements included within the spirit and scope of the claims. It is thus to be understood that modifications and variations in the present invention may be made without departing from the novel aspects of this invention as defined in the claims, and that this application is to be limited only by the scope of the claims.

The invention is claimed as follows:

1. A gaming device comprising:
a game;
a plurality of independent symbol generators in said game, each of said independent symbol generators including a plurality of symbols;
at least one terminating condition, said terminating condition including the terminator symbol and the activator symbol, wherein the activator symbol activates the terminator symbol, and wherein one of the symbol generators is adapted to generate the terminator symbol and another of said symbol generators is adapted to generate the activator symbol; and
a plurality of simultaneously generated symbols, including one symbol from each symbol generator;
whereby the game terminates when the terminating condition occurs including the simultaneous generation by the symbol generators of the terminator symbol and the activator symbol, wherein the simultaneous generation of only the terminator symbol or only the activator symbol (a) does not cause termination of the game, (b) does not cause part of the terminating condition to be satisfied, (c) does not cause an accumulation of any of the terminator symbols for subsequently achieving the terminating condition, and (d) does not cause the accumulation of any of the activator symbols for subsequently achieving the terminating condition.

2. The gaming device of claim 1, which includes an award provided to a player for each simultaneous generation of symbols by the symbol generators which does not cause the terminating condition to occur.

3. The gaming device of claim 1, wherein at least one award is associated with the terminator symbol.

4. The gaming device of claim 1, wherein at least one award is associated with the activator symbol.

5. The gaming device of claim 4, wherein the award includes one of the awards selected from the group consisting of: at least one value, at least one modifier, at least one prize, at least one credit, at least one free generation of the symbols and at least one free game.

6. The gaming device of claim 1, wherein at least one of the symbols generators includes a reel.

7. The gaming device of claim 6, wherein at least one payline is associated with the reels, wherein any award associated with the symbols indicated on one of the paylines is provided to a player.

8. The gaming device of claim 7, wherein the terminator symbol and the activator symbol are simultaneously indicated on the same payline.

9. The gaming device of claim 6, which includes a bonus award provided to a player when a predetermined number of said activator symbols are accumulated on the reels.

10. The gaming device of claim 6, which includes a bonus award provided to a player when a randomly determined number of said activator symbols are accumulated on the reels.

11. The gaming device of claim 6, which includes a probability of being indicated on the reels associated with each of the symbols on the reels.

12. The gaming device of claim 11, wherein the probabilities associated with the terminator and activator symbols are greater than at least one of the probabilities associated with the other symbols on the reels.

13. The gaming device of claim 11, wherein the probabilities associated with the terminator and activator symbols are greater than a plurality of the probabilities associated with the other symbols on the reels.

14. The gaming device of claim 11, wherein the probabilities associated with the terminator and activator symbols are greater than all of the probabilities associated with the other symbols on the reels.

15. The gaming device of claim 7, wherein the symbols indicated on one of the paylines change into a terminator symbol or an activator symbol in each spin of the reels.

16. The gaming device of claim 7, wherein the symbols indicated on one of the paylines change into a terminator symbol or activator symbol in a plurality of spins of the reels.

17. The gaming device of claim 6, wherein the reel includes a terminator symbol.

18. The gaming device of claim 17, wherein any one of the symbols on the reel including the terminator symbol change into a terminator symbol after said symbols are indicated on a designated payline associated with the reel.

19. The gaming device of claim 18, wherein the symbols indicated on the designated payline change into a terminator symbol for a designated number of spins of the reel.

20. The gaming device of claim 19, wherein the designated number of spins is predetermined.

21. The gaming device of claim 19, wherein the designated number of spins is randomly determined.

22. The gaming device of claim 18, wherein the symbols indicated on the payline change into a terminator symbol in all of the spins of the reel.

23. The gaming device of claim 6, wherein the reel includes an activator symbol.

24. The gaming device of claim 23, wherein the symbols on the reel including the activator symbol change into an activator symbol after said symbols are indicated on a designated payline associated with the reel.

25. The gaming device of claim 23, wherein the symbols indicated on the designated payline change into an activator symbol for a designated number of spins of the reel.

26. The gaming device of claim 25, wherein the designated number of spins is predetermined.

27. The gaming device of claim 25, wherein the designated number of spins is randomly determined.

28. The gaming device of claim 23, wherein the symbols indicated on the payline change into an activator symbol in all of the spins of the reel.

29. The gaming device of claim 7, which includes a plurality of pairs of symbols including one terminator symbol and one activator symbol wherein the terminator symbols are activated only when the terminator symbols and the activator symbols in the same pair of symbols are simultaneously indicated on the payline.

30. The gaming device of claim 1, wherein the symbol generators include at least one wheel.

31. A gaming device comprising:
a game;
a plurality of independent symbol generators in said game, each of said independent symbol generators including a plurality of symbols;
at least one terminating condition, said terminating condition including at least one terminator symbol and a plurality of activator symbols, wherein a designated number of the activator symbols activate the terminator symbol, and wherein one of the symbol generators is adapted to generate the terminator symbol and a plurality of said symbol generators are each adapted to generate at least one of the activator symbols; and
a plurality of simultaneously generated symbols, including one symbol from each symbol generator;
whereby the game terminates when the terminating condition occurs including the simultaneous generation by the symbol generators of the terminator symbol and at least one of the designated number of activator symbols and wherein the generation of only the terminator symbol or only the activator symbols (a) does not cause termination of the game, (b) does not cause part of the terminating condition to be satisfied, (c) does not cause an accumulation of any of the terminator symbols for subsequently achieving the terminating condition, and (d) does not cause an accumulation of any of the activator symbols for subsequently achieving the terminating condition.

32. The gaming device of claim 31, which includes an award provided to a player for each simultaneous generation of symbols by the symbol generators which does not cause the terminating condition to occur.

33. The gaming device of claim 31, wherein at least one of the symbols generators includes a reel.

34. The gaming device of claim 33, which includes a plurality of paylines associated with the reel wherein the terminator symbol is activated when at least one of the designated number of activator symbols is simultaneously indicated on the same payline as the terminator symbol.

35. A gaming device comprising:
a game;
a plurality of reels in said game, each of said reels including a plurality of symbols;
a plurality of spins associated with the reels;
at least one terminating condition, said terminating condition including at least one terminator symbol and at least one activator symbol, wherein the activator symbol activates the terminator symbol, and wherein one of the reels is adapted to generate the terminator symbol and another of said reels is adapted to generate the activator symbol; and
a plurality of simultaneously generated symbols, including one symbol from each of the reels;
whereby the game terminates when there are no spins remaining or when the terminating condition occurs including the simultaneous generation by the reels of the terminator symbol and the activator symbol and wherein the generation of only the terminator symbol or only the activator symbol (a) does not cause termination of the game, (b) does not cause part of the terminating condition to be satisfied, (c) does not cause an accumulation of any of the terminator symbols for subsequently achieving the terminating condition, and (d) does not cause an accumulation of any of the activator symbols for subsequently achieving the terminating condition.

36. The gaming device of claim 35, wherein the number of spins is randomly determined.

37. The gaming device of claim 35, wherein the number of spins is predetermined.

38. The gaming device of claim 35, wherein the number of spins is based on a player's wager.

39. The gaming device of claim 35, which includes a plurality of paylines associated with the reels, wherein the processor provides any award associated with the symbols indicated on any one of the paylines.

40. The gaming device of claim 39, wherein the terminator symbol and the activator symbol are simultaneously indicated on the same payline.

41. The gaming device of claim 35, wherein one of the reels includes a terminator symbol and each of the other reels includes an activator symbol.

42. The gaming device of claim 41, which includes a bonus award provided to a player when a predetermined number of activator symbols are indicated on the reels.

43. The gaming device of claim 41, which includes a bonus award provided to a player when a randomly determined number of activator symbols are indicated on the reels.

44. A gaming device comprising:
a game;
a plurality of symbol generators in said game, each of said symbol generators including a plurality of symbols;
at least one terminating condition, said terminating condition including at least one terminator symbol and a plurality of activator symbols, wherein at least one of the plurality of activator symbols activates the terminator symbol, and wherein one of the symbol generators is adapted to generate the terminator symbol and a plurality of said symbol generators are adapted to generate the activator symbols; and
a plurality of simultaneously generated symbols, including one symbol from each symbol generator;
whereby the game terminates when the terminating condition occurs including the sequential generation by the symbol generators of a designated number of activator symbols wherein at least one of the designated number of activator symbols is simultaneously generated with the terminator symbol, and wherein the generation of only the terminator symbol or only the activator symbols (a) does not cause termination of the game, (b) does not cause part of the terminating condition to be satisfied, (c) does not cause an accumulation of any of the terminator symbols for subsequently achieving the terminating condition, and (d) does not cause an accumulation of any of the activator symbols for subsequently achieving the terminating condition

45. The gaming device of claim 44, wherein the sequential generation of the activator symbols and the terminator symbol occur on a plurality of paylines associated with the reels.

46. The gaming device of claim 45, wherein the sequential generation of the activator symbols and the terminator symbol occur on the same payline.

47. The gaming device of claim 44, wherein the designated number of activator symbols is randomly determined.

48. The gaming device of claim 44, wherein the designated number of activator symbols is predetermined.

49. The gaming device of claim 44, wherein the designated number of activator symbols is based on a wager made by a player.

50. A method of operating a gaming device, said method comprising the steps of:
(a) displaying a plurality of symbol generators including a plurality of symbols in a game, said symbol generators adapted to generate at least one terminator symbol and another of said symbol generators adapted to generate at least one activator symbol;
(b) generating, randomly, at least one of said symbols on each of the symbol generators;
(c) providing a player any outcome associated with said symbols randomly generated on the symbol generators; and
(d) terminating the game when a terminating condition occurs, said terminating condition including the simultaneous generation of the terminator symbol and the activator symbol by the symbol generators, wherein the generation of only the terminator symbol or only the activator symbol (a) does not cause termination of the game, (b) does not cause part of the terminating condition to be satisfied, (c) does not cause an accumulation of any of the terminator symbols for subsequently achieving the terminating condition, and (d) does not cause an accumulation of any of the activator symbols for subsequently achieving the terminating condition.

51. The method of claim 50, which includes terminating the game when the terminator symbol and the activator symbol are randomly generated on at least one of a plurality of paylines associated with the reels.

52. The method of claim 51, which includes terminating the game when the terminator symbol and the activator symbol are randomly generated on the same payline.

53. The method of claim 50, which includes the step of activating the terminator symbol when a plurality of activator symbols and the terminator symbol are simultaneously indicated on a payline associated with the reels.

54. The method of claim 51, which includes the step of associating a probability of a symbol being indicated on one of the paylines, wherein the probabilities associated with the terminator symbol and the activator symbol are greater than the probability associated with at least one of the other symbols.

55. The method of claim 51, which includes the step of associating a probability of a symbol being indicated on one of the paylines, wherein the probabilities associated with the terminator symbol and the activator symbol are greater than a plurality of the probabilities associated with the other symbols.

56. The method of claim 51, which includes the step of associating a probability of a symbol being indicated on one of the paylines, wherein the probabilities associated with the terminator symbol and the activator symbol are greater than all of the probabilities associated with the other symbols.

57. The method of claim 50, wherein the steps (a) to (d) are provided to the player through a data network.

58. The method of claim 57, wherein the data network is an internet.

59. A method of playing a gaming device, said method comprising the steps of:
(a) displaying a plurality of symbol generators including a plurality of symbols in a game, said symbol generators adapted to generate at least one terminator symbol and a plurality of said symbol generators adapted to generate a plurality of activator symbols;
(b) generating, randomly, at least one of said symbols on each of the symbol generators in the game;
(c) providing a player any outcome associated with said symbols randomly generated on the symbol generators; and
(d) terminating the game when the terminator symbol and a designated number of activator symbols are simultaneously generated by the symbol generators, wherein the generation of only the terminator symbol or only the activator symbols (a) does not cause termination of the game, (b) does not cause part of the terminating condition to be satisfied, (c) does not cause an accumulation of any of any of the terminator symbols for subsequently achieving the terminating condition, and (d) does not cause an accumulation of any of the activator symbols for subsequently achieving the terminating condition.

60. The method of claim 59, which includes the step of activating the terminator symbol when the designated number of activator symbols and the terminator symbol are simultaneously indicated on a payline associated with the reels.

61. The method of claim 60, which includes the step of activating the terminator symbol when the designated number of activator symbols and the terminator symbol are simultaneously indicated on the same payline.

62. The method of claim 60, which includes the step of associating a probability of one of the symbols being indicated on a payline associated with the reels, wherein the probabilities associated with the terminator symbol and the activator symbols are greater than the probability associated with at least one of the other symbols on the reels.

63. The method of claim 60, which includes the step of associating a probability of one of the symbols being indicated on a payline associated with the reels, wherein the probabilities associated with the terminator symbol and the activator symbols are greater than a plurality of the probabilities associated with the other symbols on the reels.

64. The method of claim 60, which includes the step of associating a probability of one of the symbols being indicated on a payline associated with the reels, wherein the probabilities associated with the terminator symbol and the activator symbols are greater than all of the probabilities associated with the other symbols on the reels.

65. The method of claim 60, wherein the steps (a) to (d) are provided to the player through a data network.

66. The method of claim 65, wherein the data network is an internet.

67. A method of playing a gaming device, said method comprising the steps of:
(a) displaying a plurality of symbol generators including a plurality of symbols in a game, said symbol generators adapted to generate at least one terminator symbol and a plurality of said symbol generators adapted to generate a plurality of activator symbols;
(b) generating, randomly, at least one of said symbols on each of the symbol generators;
(c) providing a player any outcome associated with said symbols randomly generated on the symbol generators; and
(d) terminating the game when the terminator symbol and a designated number of the activator symbols are sequentially generated on the reels, wherein at least one of the activator symbols and the terminator symbol are simultaneously generated by the symbol generators, wherein the generation of only the terminator symbol or only the activator symbols (a) does not cause termination of the game, (b) does not cause part of the terminating condition to be satisfied, (c) does not cause an accumulation of any of any of the terminator symbols for subsequently achieving the terminating condition and (d) does not cause an accumulation of any of the activator symbols for subsequently achieving the terminating condition.

68. The method of claim 67, wherein the designated number of activator symbols are indicated on a payline associated with the reels.

69. The method of claim 67, wherein the designated number of activator symbols and the terminator symbol are indicated on a payline associated with the reels.

70. The method of claim 69, wherein the designated number of activator symbols and the terminator symbol are indicated on the same payline associated with the reels.

71. The method of claim 67, wherein the steps (a) to (d) are provided to the player through a data network.

72. The method of claim 71, wherein the data network is an internet.
